(19) United States
(12) Patent Application Publication
(10) Pub. No.: US 2009/0307080 A1
(43) Pub. Date: Dec. 10, 2009

(54) SHOPPING LIST MANAGEMENT AND DISCOUNT ORGANIZER

(76) Inventors: Nilesh Jain, Beaverton, OR (US); Padmashree K. Apparao, Portland, OR (US); Omesh Tickoo, Hillsboro, OR (US)

Correspondence Address: BUCKLEY, MASCHOFF & TALWALKAR LLC, 50 LOCUST AVENUE, NEW CANAAN, CT, 06840, US

(21) Appl. No.: 12/134,426

(22) Filed: Jun. 6, 2008

(51) Int. Cl. G06Q 30/00

(52) U.S. Cl. 705/14.38; 705/14.65

(57) ABSTRACT

According to some embodiments, a method and system are provided to scan a plurality of coupon identifiers into a handheld device where each coupon identifier is associated with a product coupon, categorize the plurality of coupon identifiers in a memory of the handheld device, select one or more of the plurality of coupon identifiers to transmit by scanning an identifier of one or more household products into a handheld device, and transmit the selected one or more of the plurality of coupon identifiers to an electronic cash register.

### BACKGROUND

Consumers often enjoy taking advantage of cost savings provided by coupons. Coupons are typically provided as paper coupons, such as those found in newspaper inserts and unsolicited mailings, and may be difficult to organize because they vary in physical size and shape. Also, coupons may have expiration dates causing a consumer to frequently review saved coupons to remove those that have expired.

Many consumers have their own way of organizing coupons and while some non-electronic devices are available in the market to aid users, these non-electronic devices require consumers to carry the paper coupons with them to present at a point of sale. Apart from the use of paper that adds to environmental costs, traditional coupon disbursement adds accounting overhead at the point-of-sale and requires a physical distribution channel because paper coupons have to be returned to a coupon originator for correct expensing of claims.

### BRIEF DESCRIPTION OF THE DRAWINGS

FIG. 1 illustrates a system according to some embodiments.

FIG. 2 comprises a flow diagram of a process according to some embodiments.

FIG. 3 illustrates an apparatus according to some embodiments.

### DETAILED DESCRIPTION

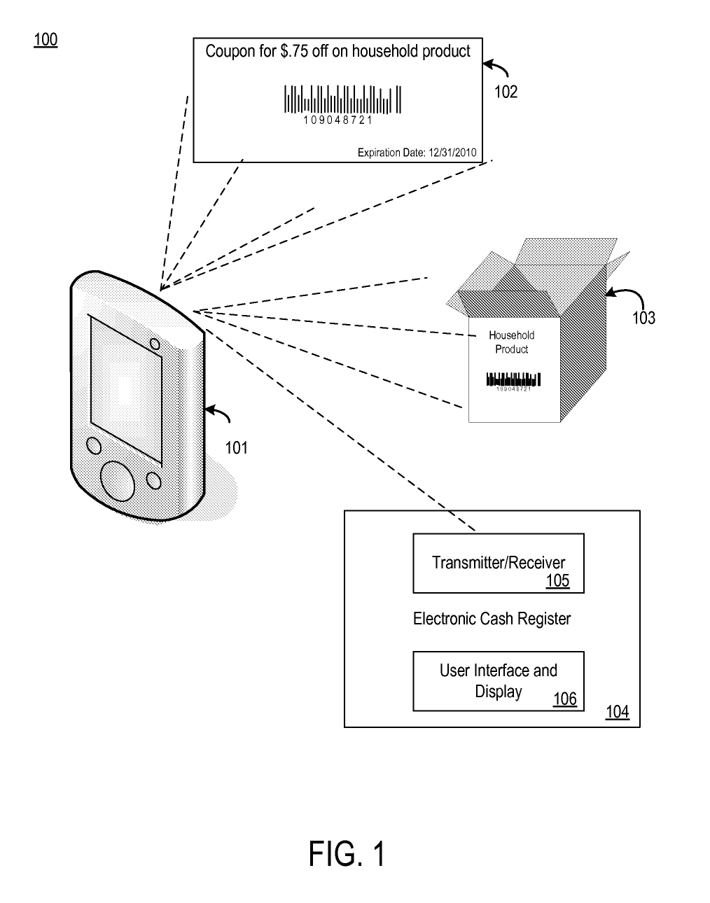

Referring now to FIG. 1, an embodiment of a system 100 is shown. The system 100 may comprise a handheld device 101, a coupon 102, a household product 103, and an electronic cash register 104. In some embodiments, FIG. 1 may illustrate a system to create a shopping list by scanning coupons and/or household products. However, in some embodiments, FIG. 1 may illustrate a system to organize coupons and to transmit coupons to a point of sale device.

The coupon 102 may comprise a plurality of information such as, but not limited to, a title (e.g., “Coupon for $0.75 off on household product), a bar code, and an expiration date (e.g., Dec. 31, 2010). The coupon 102 may also comprise information associated with purchase requirements, such as, but not limited to, “Buy two items and get one item free” or “Buy one item get the second item for 50% off”.

In some embodiments, the coupon 102 may be comprised of paper, plastic, metal or any known material. In some embodiments, the coupon may be embedded with a radio-frequency identification (RFID) tag or transponder. An RFID tag may be an object that is applied to or incorporated into a product to identify the product using radiowaves. RFID tags may be readable from an RFID reader.

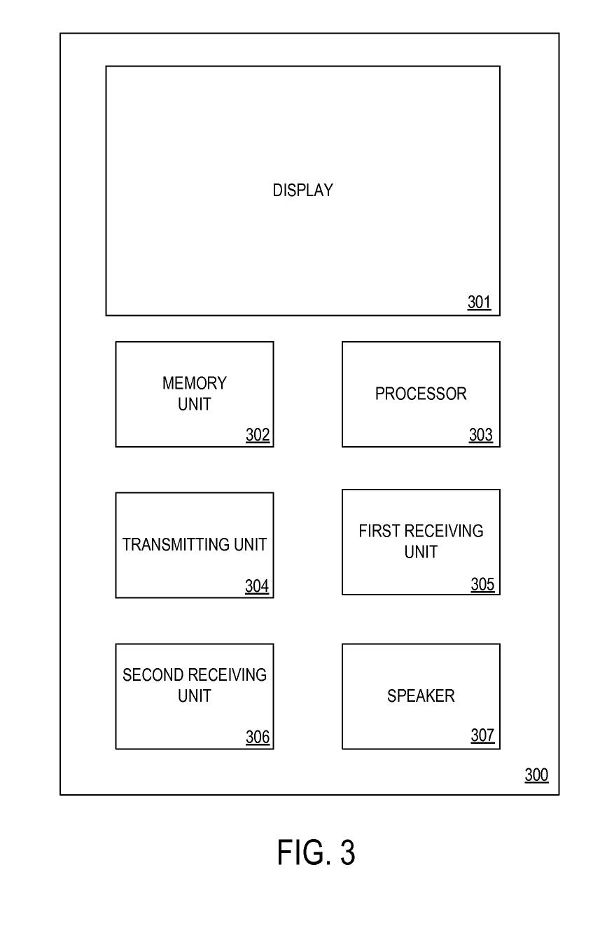

The handheld device 101 may comprise an electronic device that is frequently carried by a consumer such as, but not limited to, a cell phone, a personal data assistant, a digital camera, or an MP3 music player. The handheld device 101 may comprise a receiver and a transmitter (shown in FIG. 3) to input information associated with the coupon 102 and to transmit the coupon information to the electronic cash register 104 respectively. A consumer may scan or enter the coupon information into the handheld device 102 via a built-in camera, bar-code reader, or RFID reader.

The household product 103 may comprise, but is not limited to, any product, food, consumable, or a wrapper/container of said product, food or consumable. In some embodiments, the electronic cash register 104 may be a point of sale device.

The electronic cash register 104 may comprise a transmitter/receiver 105 and a user interface and display 106. The transmitter/receiver 105 may transmit to and receive information from the handheld device 101. In some embodiments, the transmitter/receiver 105 may comprise a RFID unit, a Bluetooth unit, and/or a bar code scanner. The user interface and display 106 may indicate items purchased and their respective price before a coupon is applied, a price after a coupon is applied, coupons that will be applied to items purchased, and a total cost of all items. The electronic cash register 104 may also provide a means for a consumer to pay for their items.

The handheld device 101 may comprise image-processing software to capture an image of the coupon 102 (e.g., when a consumer scans the coupon 102 via a built-in camera), processes the coupon image, and parse all relevant information contained within the coupon image to a coupon management application software that will organize the parsed coupon information into a coupon record stored internally in a local database.

A consumer may scan a plurality of coupons 102 with the handheld device 101. Information associated with each coupon may be entered into the local database as a database record (e.g. coupon record).

While shopping, the handheld device 101 may identify each household product 103 added to a physical shopping cart and in response to identifying each household product 103, the handheld device 101 may indicate in the database if each added household product is associated with a coupon record. In some embodiments, products in the shopping cart may be identified when a consumer scans a barcode of each respective household product being purchased via the handheld device 101.

During checkout, once each product is indicated as being associated with a coupon record, the handheld device 101 may establish a link with the electronic cash register 104 via a pre-negotiated wireless interface to retrieve household product purchase information, and then, based on that identification of the household products 103 in the consumer's cart, pull all the relevant coupon records for an appropriate cost deduction. The handheld device 101 may transmit all indicated coupon records to the electronic cash register 104 by a wireless interface or by providing scannable bar codes on a display of the handheld device 101 that will be scanned by a bar code scanner of the electronic cash register 104. In some embodiments, the handheld device 101 may transmit the bar codes of the scanned product as well as the coupon records. In some embodiments, if the electronic cash register 104 is RFID enabled, the handheld device 101 may transmit identified coupon records using radio frequency (RF) signals.

In an embodiment where a coupon may require a confirmation code or personal consumer information prior to approval, the electronic cash register 104 may communicate with an originator of the coupon, receive a request for information from the originator, and transmit the request to the handheld device 101 to allow the consumer to enter the information into the handheld device 101 and then transmit the information back to the electronic cash register 104.

In some embodiments, a coupon that is limited by a maximum number of uses may be associated with a portable device ID (e.g., a medium access control identifier) and a coupon originator may count a number of uses of the coupon. Furthermore, the database may also contain the number of uses so the handheld device may be able to limit a number of times a consumer uses a coupon. In some embodiments, the handheld device 101 may indicate a number of items purchased such as in an example of when a coupon is based on a premise of “buy 2 get one free”.

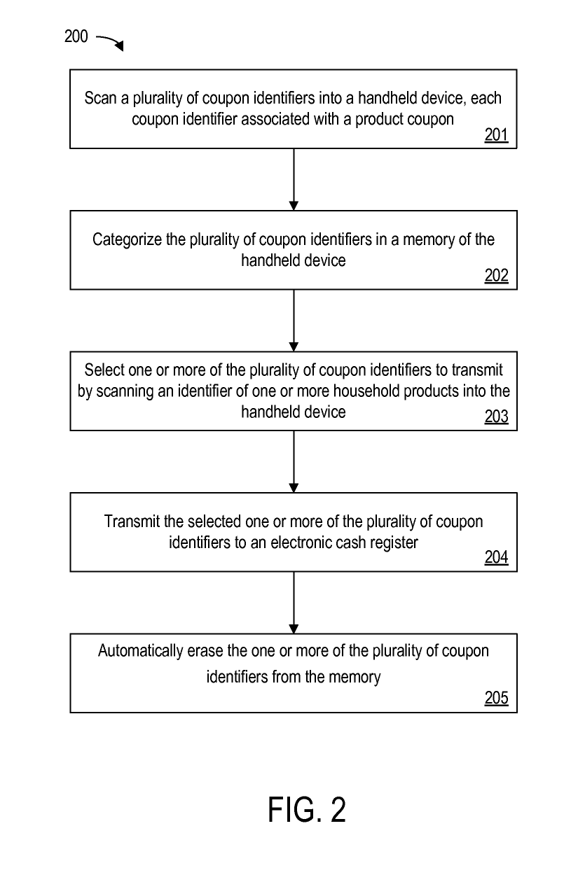

Now referring to FIG. 2, an embodiment of a method 200 is illustrated. Some embodiments of method 200 may be performed by a system, such as, but not limited to, system 100 of FIG. 1. Some embodiments of method 200 may reduce a users need to organize coupons and to carry paper coupons while shopping.

At 201, a plurality of coupon identifiers are scanned into a handheld device, each coupon identifier being associated with a product coupon. In some embodiments, the plurality of coupon identifiers may be scanned into a handheld device via a digital camera integral to the handheld device in a form of a digital photograph. In another embodiment, the plurality of coupon identifiers may be scanned into a handheld device via a bar code scanner that is integral to the handheld device. In yet another embodiment, the plurality of coupon identifiers may be scanned into a handheld device via an RFID reader integral to the handheld device in a form of RFID tag information.

For illustrative purposes, and to aid in understanding of features of the present application, an example will now be introduced. This example is not intended to limit the scope of the present application.

A consumer may receive a mailing from a local newspaper comprising a plurality of coupons. The consumer may not remember if he uses each product listed in the mailing but the consumer may take a photograph of each coupon of the plurality of coupons with his handheld device such as handheld device 101.

Next at 202, the plurality of coupon identifiers is categorized in a memory of the handheld device. In some embodiments, categorizing the plurality of coupon identifiers may comprise storing the coupon identifier in a memory of handheld device, identifying an expiration date associated with each of the plurality of coupon identifiers, adding the coupon identifier to a coupon database and indexing the coupon identifier by category. In some embodiments, the coupon identifier may be categorized by product type, brand name, and/or expiration date.

Continuing with the above example, the consumer may have scanned in a first coupon for $1.00 off Brand X laundry detergent, a second coupon for $0.75 off of a jar of Brand Y pickles, and a third coupon for “buy two bars of Brand Z soap, get one free”. The photographs of each coupon may be processed by image processing software to parse all relevant information associated with each coupon from the coupons and the information may be stored as a data record in a local database. Each coupon identifier stored in a data record may be associated with a product type (e.g. pickles, laundry detergent, or soap).

After the coupon identifiers are categorized, one or more of the plurality of coupon identifiers are selected to be transmitted by scanning an identifier of one or more household products into a handheld device at 203.

In some embodiments, selecting the one or more coupon identifiers by scanning an identifier of a household product into a handheld device may comprise scanning an empty household product. Continuing with example from 202, when a consumer discovers that a product at his house is empty, or near empty, the consumer, via the handheld device, may scan (e.g. via reading an RFID tag, via reading a barcode, or via photographing a barcode) the empty or near empty product. The empty or near empty product may be entered into a shopping list on the handheld device. Furthermore, in response to the scanning of the product, the handheld device may determine if the scanned product is associated with any coupon identifiers stored in a database. For example, if the consumer were to scan in an empty or near empty box of Brand X laundry detergent, the handheld device may query the database for Brand X laundry detergent and since an identifier for this coupon exists in the database, a database field may be marked to indicate that the coupon information associated with Brand X laundry detergent will be transmitted. Furthermore, the handheld device may indicate (via a sound or display) that a coupon exists for the currently scanned in product. However, if the consumer were to scan in a box of Brand Z laundry detergent, and since no coupon is associated with Brand Z laundry detergent, the handheld device may indicate (via a sound or display) that no coupon exists.

In some embodiments, selecting the one or more coupon identifiers by scanning an identifier of a household product into a handheld device may comprise scanning a new household product. Continuing with example from 202, when a consumer places a product into his shopping cart, the handheld device may scan (e.g. via reading an RFID tag, via reading a barcode, or via photographing a barcode) the product being placed into the shopping cart. In response to the reading or scanning of the product, the handheld device may determine if the scanned product is associated with any coupon identifiers stored in a database. For example, if the consumer were to scan in a jar of Brand Y pickles as the consumer was placing the jar of Brand Y pickles into his shopping cart, the handheld device may query the database for Brand Y pickles and since an identifier for this coupon exists in the database, a database field may be marked to indicate that the coupon information associated with Brand Y pickles will be transmitted and the handheld device may indicate (via a sound or display) that a coupon exists for the currently scanned in product.

In some embodiments, a consumer may be prompted on the handheld device 101 with a price of the household product 103 after a coupon has been applied to a household product and the consumer may be required to make a decision if the household item 103 will be purchased. Additionally, the handheld device 101 may provide a list of various related products with available rebates and final prices to help the consumer make a purchase decision. In some embodiments, the list of various related products may be based on price, may be based on an expiration date of existing coupons, may be based on a merchant, or may be based on a manufacturer.

At 204, the selected one or more of the plurality of coupon identifiers are transmitted to an electronic cash register. In some embodiments, each database entry that is indicated for transmission is transmitted.

For example, and continuing with the above example, if Brand Y Pickles and Brand X laundry detergent were indicated for transmission, then these coupon identifiers and any related or required information associated with the coupon identifiers will be sent electronically to an electronic cash register when a consumer selects a transmission option on his handheld device.

At 205, the one or more of the plurality of coupon identifiers are automatically erased from the memory. In some embodiments, the memory may be automatically erased based on either an expiration date of the coupon or based on an indication that a coupon identifier has been transmitted. For example, and continuing with the above example, if coupon information for Brand Y Pickles and Brand X laundry detergent was sent electronically to an electronic cash register, then these data records may be erased from the database.

Now referring to FIG. 3, an embodiment of an apparatus 300 is illustrated. In some embodiments, the apparatus 300 may comprise a handheld device such as handheld device 101. Apparatus 300 may comprise a display 301, a memory unit 302, a processor 303, a transmitting unit 304, a first receiving unit 305, a second receiving unit 306, and a speaker 307.

The display 301 may comprise, but is not limited to, a liquid crystal display (LCD), a plasma display, or any other display that is or will be known.

The memory unit 302 may store, for example, applications, programs, procedures, and/or modules that store instructions to be executed. The memory 302 may comprise, according to some embodiments, any type of memory for storing data, or a computer readable medium, such as a Single Data Rate Random Access Memory (SDR-RAM), a Double Data Rate Random Access Memory (DDR-RAM), or a Programmable Read Only Memory (PROM). In some embodiments, the memory unit 302 may store a coupon database.

The processor 303 may comprise any computer processor. In some embodiments, the processor may comprise a multi core processor having two or more processor cores.

The transmitting unit 304 may comprise, but is not limited to, a Bluetooth transmitter, an RF transmitter, or a barcode display device that functions in conjunction with the display 103.

The first receiving unit 305 and the second receiving unit 306 may comprise a bar code reader, a digital camera, or an RFID reader. In some embodiments, and since only some household products may comprise an RFID tag, a handheld device may comprise two units to receive information such as including both a bar code reader and an RFID reader. However, in some embodiments, the handheld device may only comprise a single receiving unit 305.

The speaker 307 may comprise any speaker that is or will be known. In some embodiments, the speaker 307 may indicate, via a ring tone or other sound, that one or more coupon indicators have been transmitted to an electronic cash register. In some embodiments, the apparatus 300 may comprise a speech synthesizer and, the speaker 307 may indicate a total amount saved. For example, the speaker may indicate “You have saved three dollars and fifty cents today”.

Various modifications and changes may be made to the foregoing embodiments without departing from the broader spirit and scope set forth in the appended claims.

What is claimed is:

1. A method comprising:
scanning a plurality of coupon identifiers into a handheld device, each coupon identifier associated with a product coupon;
categorizing the plurality of coupon identifiers in a memory of the handheld device;
selecting one or more of the plurality of coupon identifiers to transmit by scanning an identifier of one or more household products into the handheld device; and
transmitting the selected one or more of the plurality of coupon identifiers to an electronic cash register.

2. The method of claim 1, further comprising:
automatically erasing the one or more of the plurality of coupon identifiers from the memory based on an expiration date or based on an indication that a coupon identifier has been transmitted.

3. The method of claim 1, wherein scanning the plurality of coupon identifiers is via a digital camera integral to the handheld device.

4. The method of claim 1, wherein scanning the plurality of coupon identifiers is via an RFID reader integral to the handheld device.

5. The method of claim 1, wherein scanning the plurality of coupon identifiers is via a barcode scanner integral to the handheld device.

6. The method of claim 1, wherein categorizing the plurality of coupon identifiers comprises:
storing the coupon identifier in the memory;
identifying an expiration date associated with each of the plurality of coupon identifiers; and
adding the coupon identifier to a coupon database.

7. The method of claim 1, wherein selecting the one or more coupon identifiers by scanning an identifier of a household product into a handheld device comprises:
scanning an empty household product.

8. The method of claim 1, wherein selecting the one or more coupon identifiers by scanning an identifier of a household product into a handheld device comprises:
scanning an new household product.

9. An apparatus comprising:
a receiving unit to receive a plurality of coupon identifiers;
a memory unit to store the plurality of coupon identifiers;
a transmitting unit to send one or more of the plurality of coupon identifiers to an electronic cash register;
a processor; and
a computer-readable medium storing instructions that when executed by the processor perform a method, the method comprising:
receiving the plurality of coupon identifiers via the receiving unit;
categorizing the plurality of coupon identifiers in the memory unit;
selecting one or more of the plurality of coupon identifiers by scanning an identifier of a household product; and
transmitting the selected one or more of the plurality of coupon identifiers via the transmitting unit.

10. The apparatus of claim 9, wherein the receiving unit comprises a digital camera.

11. The apparatus of claim 9, wherein the receiving unit comprises an RFID reader.

12. The apparatus of claim 9, wherein the receiving unit comprises a barcode scanner.

13. The apparatus of claim 9, wherein the transmitting unit comprises a blue tooth transmitter.

14. The apparatus of claim 9, wherein selecting the one or more coupon identifiers by scanning an identifier of a household product comprises:
scanning an empty household product.

15. The apparatus of claim 9, wherein selecting the one or more coupon identifiers by scanning an identifier of a household product comprises:
scanning a new household product.
